(19) United States
(12) Patent Application Publication
(10) Pub. No.: US 2007/0227025 A1
(43) Pub. Date: Oct. 4, 2007

(54) Handy, multi-purpose tile installation alignment and spacer tools

(76) Inventor: Darrell Miller Venture, Pensacola, FL (US)

Correspondence Address: DARRELL M. VENTURE (V-SOLUTIONS, LLC), APT 20, 8917 N. DAVIS HWY, PENSACOLA, FL, 32514, US

(21) Appl. No.: 11/392,273

(22) Filed: Mar. 30, 2006

(51) Int. Cl. G01D 21/00

(52) U.S. Cl. 33/527

(57) ABSTRACT

The present invention overcomes a problem in conventional tile installation by providing tile installation alignment and spacer tools to quickly provide straight alignment of and proper grout spacing betveen tiles. In addition, the invention helps to provide a more consistent, level finished surface.

### TECHNICAL FIELD

This invention relates to an improved apparatus for installing ceramic tile, brick, block and the like. In particular, the invention relates to a set of installation alignment and spacer tools that allow rapid alignment and proper grout spacing, to enhance the ease of installing tile, and a more consistent, level finished surface to improve the final appearance of newly laid tile.

### BACKGROUND ART

Tile provides not only an especially aesthetically pleasing look, but also a durable surface for a variety of residential and industrial settings. Tile work is generally considered an improvement upgrade to a kitchen, floor, bathroom, and the like, where ceramic tile is installed on the underlayment of either a floor or wall, or both.

With the strong, present economy, individuals and businesses have generated a greater amount of disposal income that can be put toward general home and business improvements. A vast majority of these improvements comprise an element of new tile work to a kitchen and bathroom, as the walls and floors are reconditioned and upgraded to new ceramic tile surfaces. Even without the present robust economy, there has always been, and will remain, a large amount of ongoing tile work associated with new construction.

Further, there has also been a concurrent explosion in the construction of home improvement mega-stores which supply the every expanding class of do-it-yourselfers (those finding more pleasure in tackling home and business projects themselves than hiring outside contractors) with the parts and confidence to complete their own improvement jobs. This growth has, in turn, produced a large market of home and business improvement books, Internet services providing step-by-step instructions, and TV shows and video programs for the do-it-yourselfers.

The present invention provides novel tile installation alignment and spacer tools that are simple enough to be employed by one with little or no skill in laying tile. The present invention is further economically justified for use by experienced contractors since the present invention shaves valuable time off the average professional job, and produces a better aligned tile surface, which can lower the repair cost of mislaid tile.

In the process of covering floor, wall and counter surfaces with ceramic tile and the like, individual tiles, or sheets of mosaic glued to a mesh webbing, are individually set into either some form of adhesive, or some form of mortar. In the process of setting the individual pieces, it is known to use tile spacers to assist in achieving uniformly sized grout spacing between the tiles or sheets of mosaic. These are typically in the shape of a cross, so as to define a corner where four tiles will intersect. The spacers are typically made of semi-rigid plastic having depths ranging from ⅛ to 3/16 of an inch, with spacing widths of between 1/16 of an inch and ⅜ of an inch. For brick, coment block and larger tiles, larger sizes of spacers, with considerably more depth, are used.

The spacers are sometimes used edgewise as an aid to laying out an array of tiles where a long row of dry tiles can be laid out, set apart by the edgewise spacers. Such spacers also are sometimes used edgewise as stacking spacers for vertical installations (wall tiles). However, while these smaller T spacer devices work well for tile spacing, they do not do well to set alignment of several tiles (and the like) over a distance. The grout line is therefore not as straight as can be achieved easily with this invention.

Most tile layers have large, heavily callused fingers and find working with small tools difficult and hard to handle. While working with newer tile spacers is easier, it is difficult and time consuming to handle the large amount of them required for tiling. Additionally, they provide no guide to the proper alignment of the lay of the tiles (the uniformness of the grout line across several tiles) as the job proceeds, or help to assist in leveling the tiles once set.

To achieve a uniformly straight tiling layout across several tiles, the procedure is to chalk a straight reference line directly onto the prepared under floor. Thin set mortar is then worked up to the line, several tiles are set, and a make shift straight-edge of sorts is placed against the edge of the tiles for final alignment. This process is time consuming and does not allow for the optimum working of the thin set mortar onto the prepared under floor. This invention will substantially reduce the amount of time to achieve final alignment by allowing the tile installer to work more thin set mortar onto the prepared under floor, over a larger area, and directly over a portion of the chalked reference line. In addition, fewer smaller tile spacers will be required.

### DISCLOSURE OF INVENTION

Objects of the invention include provision of tile installation alignment and spacer tools which are easy to handle, which are easily removed after use, which assist in establishing a uniform and straight lay of the tiles, and which will reduce the time to tile.

According to the present invention, the tile installation alignment and spacer tools include a thin, semi-rigid platform having a varied length straight tile spacer on one side thereof and a handling device (handle) on the other side thereof.

The platform, which may typically be rectangular, assists in establishing a uniform lay of tiles, and holds a portion of the alignment and spacer tool up above the tiles so it is accessible for removal. The handle on the platform is used principally to handle and manipulate the tool, with the underside protrusion of the tool used to space the intersection of two tiles side-to-side, to align a series of sets of two tiles side-by-side in plane, and to assist in a uniform level of the tiles. The tile installation alignment and spacer tools also serve for vertical tile installations and as ajob layout spacer. The tile installation alignment and spacer tools in accordance with the present invention are easily handled since they can be gripped by the handle when being inserted for use and when being removed. It is also more easily removed once its purpose has been served. It is also intended to be used along with standard use single spacers, albeit with a lesser amount of them now required, which continue to serve for corner (either cross or tee as the case may be), as well as for small and tight straight spaces. The tile installation alignment and spacer tools in accordance with the present invention are scalable to suit a variety of uses, including tile, stone, slate, brick and block, etc.

Other objects, features and advantages of the present invention will become more apparent in the light of the following detailed description of exemplary embodiments thereof, as illustrated in the accompanying drawing.

### BRIEF DESCRIPTION OF THE DRAWINGS

FIG. 1 is a top perspective view of the set of tile installation alignment and spacer tools in accordance with the present invention;

FIG. 2 is a front plan view of the edge of any one of the tools in use and in accordance with the present invention;

FIG. 3 is a top perspective view of the smallest sized of the tile installation alignment and spacer tools of FIG. 1 in use setting tile;

FIG. 4 is a top, side, and front plan view of the tile installation alignment and spacer tool of FIG. 3;

FIG. 5 is a more detailed top perspective view of two of the tile installation alignment and spacer tools shown in FIG. 1;

FIG. 6 is a top perspective view of the middle sized tile installation alignment and spacer tool of FIG. 1 in use setting tile;

FIG. 7 is a top, side, and front plan view of the tile installation alignment and spacer tool of FIG. 6;

FIG. 8 is a top perspective view of the larger sized tile installation alignment and spacer tool of FIG. 1 in use setting tile;

FIG. 9 is a top, side, and front plan view of the tile installation alignment and spacer tool of FIG. 8;

FIG. 10 is a top perspective view of the larger sized tile installation alignment and spacer tool of FIG. 1 in use to set, space, and align under floor backer board material.

### DETAILED DESCRIPTION OF THE PREFERRED EMBODIMENT

Floor tiles are best centered in the room at a doorway for visual appearance or a prominent window. The center of two opposite walls are first measured, and these points used to snap a chalk line across the length of the room in the center of the floor, dividing the room in half. Another chalk line is snapped perpendicular to the first so the two lines cross in the center of the room. A row of tiles are dry-fit down both lines to the width and length of the room, while leaving a little spacing for the grout joints.

Once the layout is established, the tile is set. The floor surface must be clean of dust and debris. Concurrently, the tile adhesive only in the amount to be used within 2-3 hours is prepared, which prevents the adhesive from drying out. The full tiles are set first, leaving any cut tiles around the perimeter of the room for last. To install floor tile, the tile is laid from the center of the floor where the two final reference lines cross. A tile at the intersection of the lines is first placed, then, using the lines as a guide, tiles are laid outward toward the walls in each quadrant. The adhesive is spread with the trowel's notched edge, combing it out in beaded ridges. Spaces between ridges of adhesive should be almost bare.

The first tile in a corner is laid and twisted into the adhesive. About 70-80 percent of the tile backing should be covered with adhesive upon inspection. The remaining tiles are then set aligned to the outside layout lines. Keeping consistent spacing between the tiles is critical for straight, uniform grout lines. Some tiles come pre-mounted on paper grids so the spacing is already established. Once the tiles are in place, they are set into the adhesive so that they are all at the same height.

After setting all of the full tiles one can measure, cut and set the tile around the edges. If installing a tile floor that runs longer than 24 feet, or if the floor is near an outside wall or exposed to areas that will expand due to temperature and moisture changes, one will need to account for expansion joints. Expansion joints are simply breaks in the tile field that protect and cushion the tile from movements in the underlayment. In most homes, expansion joints can be made by stopping the perimeter tile ¼ inch from the wall.

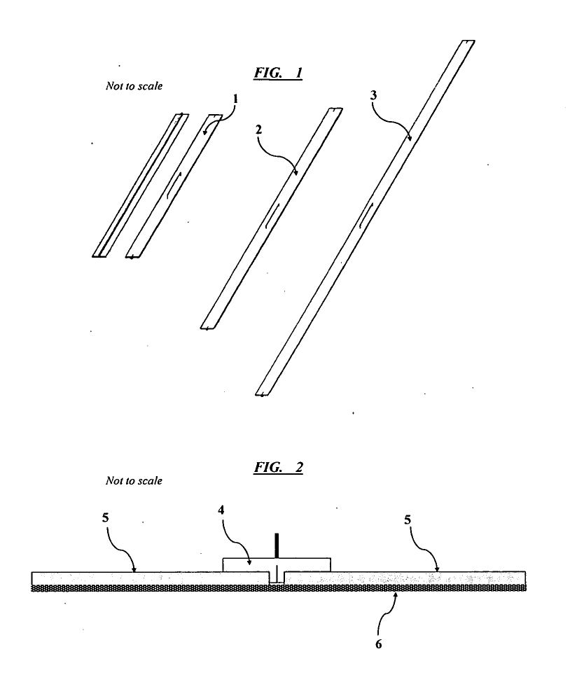

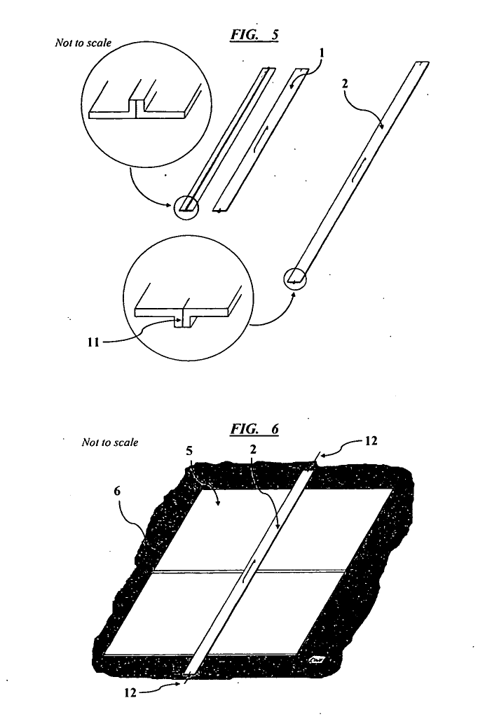

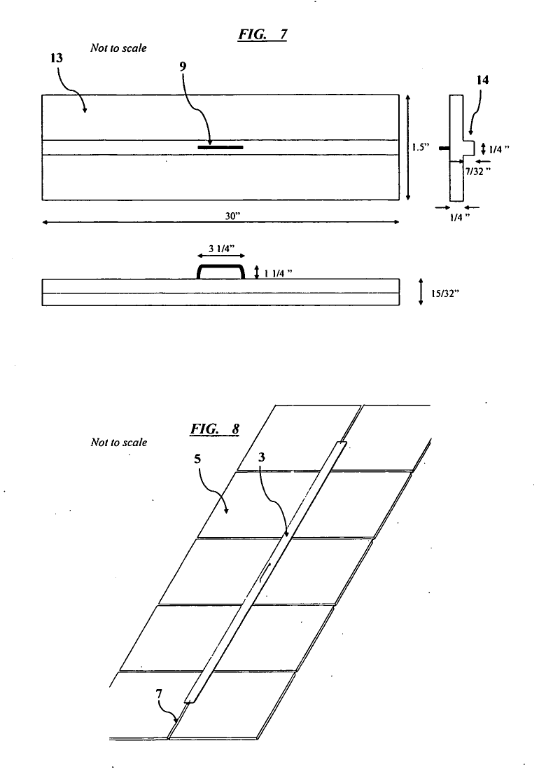

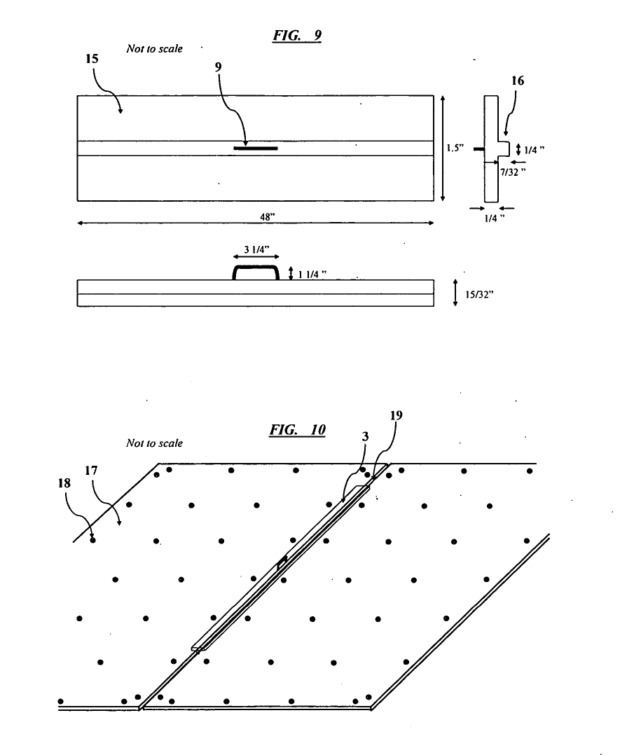

Referring to FIGS. 1, 4, 7, and 9, the tile installation alignment and spacer tools 1, 2, 3 in accordance with the present invention include a platform portion 8, 13, 15 of coplanar, flat surfaces thereof. Elongated, a single raised ridge extends outwardly of the faces of the platform 8, 13, 15 to form straight alignment and spacer elements 10, 14, 16 extending across the surface 8, 13, 15, respectively. The platform portion 8, 13, 15 and ridges 10, 14, 16 are all made of a unitary piece of semi-rigid material, such as plastic or metal. In the embodiment disclosed herein, the platform 8, 13, 15 is a rectangle of varied lengths 1.5; 2.5, and 4.0 feet, although it need not necessarily be of that exact length. It could be of any length that will provide a platform of reasonable usefulness. Referring also to FIGS. 5, 6, the straight alignment and spacer elements 10, 14, 16 are coaligned with reference line 11, the edge of the installation alignment and spacer tools 1, 2, 3 so as to permit orienting the tools 1, 2, 3 to the tiling reference line (blue chalk line) 12, with respect to the tile being laid, while using the handle 9 to maneuver the tool. For normal tile (such as is used on kitchen counters, bathroom walls, and floors) the tools may have an alignment and spacer element 10, 14, 16 just under 7/32 inch in depth and ¼ inch in width. The platform may be about ⅛ inch thick, or it may be thicker, up to about ¼ inch. That is, the grouting width to be achieved and therefore the width of the spacer may range from 1/32 of an inch up to ½ of an inch, or more, and the depth may vary from about ⅛ of an inch to ¼ of an inch, or more, depending upon the desired grout line width and what the tools are to be used for. Of course, much larger tools will be used to handle cement block, glass brick and the like.

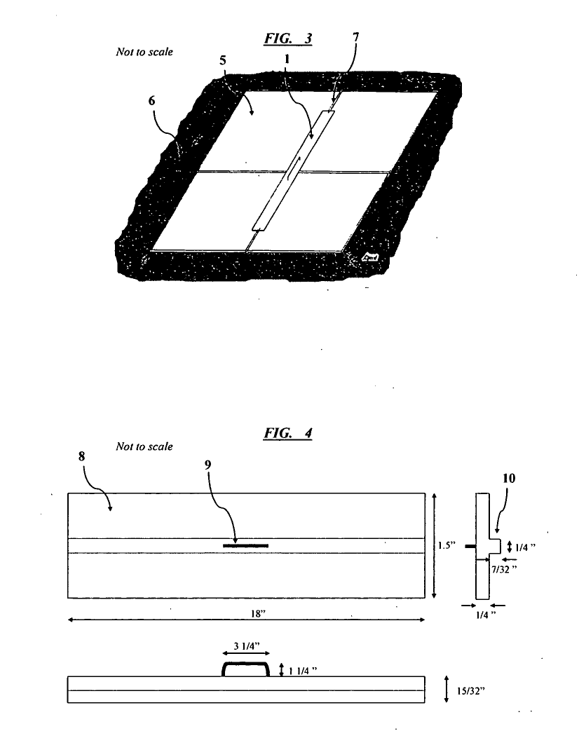

An illustration of the basic idea for a generic view of each tool, 4, is shown in FIG. 2. A more descriptive set of illustrations of the typical use of the tools 1, 2, 3 of FIG. 1 to line up an orthogonal, symmetrical array of four to ten one foot square standard floor tiles 5, is shown in FIGS. 3, 6, 8. Therein, the tools 1, 2, 3 are in the position shown in FIGS. 3, 6, 8 with the alignment and spacer elements 10, 14, 16 facing downward, and the handle 9 used to maneuver the tool. Notice that tools 1, 2, 3 not only assist in laying out the spacing between the tiles 5 so as to provide an orthogonal arrangement with uniform grout spaces 7, but it also establishes a uniform lay (without lippage) by assisting in causing the off-surface displacement of the tips of the tiles 5 to be more nearly uniform: If any of the tiles 5 are not laying flat, the uneven lay of the tool is readily apparent, and the tool can be easily removed so as to correct the lippage or pressure can be applied to the tool, that in turn will provide uniform pressure to level out the tiles.

The use of the present invention is not limited to tiles alone. FIG. 10 describes the spacing of backerboard material, or any material in fact, that requires uniform spacing. Rather than using nails, as is common, in FIG. 10 the larger length tool 3 is used to space backerboard material 17 to achieve uniform spacing 19. Naturally the backerboard is secured by screws 18, or by other means.

Thus, although the invention has been shown and described with respect to exemplary embodiments thereof, it should be understood by those skilled in the art that the foregoing and various other changes, omissions and additions may be made therein and thereto, without departing from the spirit and scope of the invention.

1-9. (canceled)

10. A tool for facilitating installation of an array of tiles separated by a grout spacing, said tool comprising:
a platform portion having coplanar flat surfaces on opposing sides thereof, said platform portion positionable upon side-by-side-positioned tiles of the array of tiles and said platform configured to provide uniform pressure, responsive to applied pressure, to level the side-by-side-positioned tiles therebeneath; and
a ridge forming a spacer comprised of an underside protrusion extending outwardly of a coplanar flat surface of the coplanar flat surfaces of said platform portion, said ridge positionable at the grout spacing separating the side-by-side-positioned tiles, the spacer formed of side ridge of a width defining a width of the grout spacing separating the side-by-side-positioned tiles.

11. The tool of claim 10 further comprising a handle positioned at a coplanar flat surface of said platform at a side thereof opposing the coplanar flat surface outwardly of which said ridge extends.

12. The tool of claim 10 wherein said platform portion is of a selected length between one and one half feet and four feet.

13. The tool of claim 10 wherein said platform and said ridge are comprised of at least one of: a semi-rigid plastic material, wood, and a metal material.

14. The tool of claim 10 wherein said ridge extends along substantially an entire length of said platform.

15. The tool of claim 10 wherein said platform and said ridge are comprised of a unitary piece of semi-rigid material.
